(19) United States
(12) Patent Application Publication
(10) Pub. No.: US 2005/0229582 A1
(43) Pub. Date: Oct. 20, 2005

(54) Rhenium Reactor

(75) Inventor: Roger Rhenium, Chicago, IL (US)

Correspondence Address: ROGER RHENIUM, 5549 1/2 N. MAGNOLIA, CHICAGO, IL, 60640, US

(73) Assignee: Roger Rhenium, Chicago, IL (US)

(21) Appl. No.: 10/906,953

(22) Filed: Mar. 14, 2005

Related U.S. Application Data
(63) Continuation of application No. 09/682,270, filed on Aug. 12, 2001.

(51) Int. Cl. F03G 7/10

(52) U.S. Cl. 60/200.1

(57) ABSTRACT

An innovated way of producing propulsion by rotating a bent circular tube while mass is circulating thru it.

A hollow closed end circular tube either metal or rigid in nature and is constructed so half of the tube is at a 90 degree angle with respect to the other half of tube.

When mass such as metal balls or a liquid are circulating thru this tube and the tube itself is rotated on its axis simultaneously propulsive torque is generated in one direction.

1. My invention is a hollow closed end circular tube bent at 90 degrees which creates propulsive torque in one direction when it is rotated 90 degrees on its axis while mass is being circulated thru it.

2. I further claim that various methods of rotating this tube may be employed to achieve sustained propulsion without diminishing the principle or function of tube.

3. I further claim that various methods of circulating mass thru this tube may be employed without diminishing the principle or function of tube.
